(19) United States
(12) Patent Application Publication
(10) Pub. No.: US 2006/0186589 A1
(43) Pub. Date: Aug. 24, 2006

(54) Method and apparatus for damping vehicle noise

(76) Inventors: Yang-Tse Cheng, Rochester Hills, MI (US); Thomas Arthur Perry, Bruce Township, MI (US); Mark W. Verbrugge, Troy, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/062,101

(22) Filed: Feb. 18, 2005

(51) Int. Cl. F16F 5/00

(52) U.S. Cl. 267/292; 267/151; 267/140.14

(57) ABSTRACT

A vehicle having a chassis with a body and a drive train disposed on the chassis is disclosed. The drive train includes a metal housing having a void and a damping element disposed within the void. Also disclosed is a controller for damping vehicle noise that includes a processing circuit for executing instructions for: receiving a signal representative of a sensed vibration at a metal housing of the vehicle; in response to the sensed vibration, generating a control signal to activate a camping element disposed at a void within the metal housing; and causing the damping element to change in such a manner as to change the damping characteristics at the void of the metal housing.

### BACKGROUND OF THE INVENTION

The present disclosure relates generally to a method and apparatus for damping vehicle noise, and particularly to a method and apparatus for damping engine noise of a vehicle.

Vehicle engine noise transmitted to the passenger compartment of the vehicle contributes to rider discomfort. In an effort to reduce the transmission of noise from the engine to the passenger compartment, a variety of techniques have been employed, including the use of polymer coatings on engine parts, sound absorbing barriers, and laminated panels having viscoelastic layers. Other noise reducing efforts have included the use of noise reducing engine mount designs, including active engine mounts that employ magnetorheological fluid actuators. While existing noise reducing efforts may have a positive effect on reducing the transmission of noise to the passenger compartment, there still remains a need in the art to address the problem associated with the source of the noise. Accordingly, there is a need in the art for alternative ways to dampen vehicle noise.

### BRIEF DESCRIPTION OF THE INVENTION

An embodiment of the invention includes a vehicle having a chassis with a body and a drive train disposed on the chassis. The drive train includes a metal housing having a void and a damping element disposed within the void.

Another embodiment of the invention includes an engine block for a vehicle having a housing with a void and a damping element disposed within the void.

A further embodiment of the invention includes a method of damping vehicle noise. A vibration is sensed at an engine of the vehicle. In response to the sensed vibration, a control signal is generated to activate a damping element disposed at a void within the engine. In response to the control signal, the damping element is caused to change in such a manner as to change the damping characteristics at the void of the engine.

Yet another embodiment of the invention includes a controller for damping vehicle noise. The controller includes a processing circuit, and a storage medium, readable by the processing circuit, storing instructions for execution by the processing circuit for: receiving a signal representative of a sensed vibration at a metal housing of the vehicle; in response to the sensed vibration, generating a control signal to activate a damping element disposed at a void within the metal housing; and causing the damping element to change in such a manner as to change the damping characteristics at the void of the metal housing.

### BRIEF DESCRIPTION OF THE DRAWINGS

Referring to the exemplary drawings wherein like elements are numbered alike in the accompanying Figures:

FIG. 1 depicts in block diagram view an exemplary vehicle in accordance with an embodiment of the invention;

FIG. 2 depicts in isometric view a portion of an exemplary engine in accordance with an embodiment of the invention;

FIG. 3 depicts in block diagram view an exemplary damping element in accordance with an embodiment of the invention; and

FIGS. 4A-4C depict in block diagram section cut view exemplary active damping devices in accordance with embodiments of the invention.

### DETAILED DESCRIPTION OF THE INVENTION

An embodiment of the invention provides a damping element for damping noise resulting from the vibration of an engine block of a vehicle. In an embodiment, the engine block includes a plurality of voids, and within the voids damping elements are placed. The damping elements may be passive or active. In an exemplary embodiment, a passive damping element is an elastomeric material, and an active damping element is a magnetorheological device. However, alternative embodiments will be discussed below. While the embodiment described herein depicts an engine block as an exemplary housing having voids for receiving the damping elements, it will be appreciated that the disclosed invention is also applicable to other housings, such as but not limited to transmission housings, timing belt housings, valve train housings, shock absorber towers, and metal castings of any kind, for example, or metal housings of any kind capable of having a void formed therein for receiving a damping element.

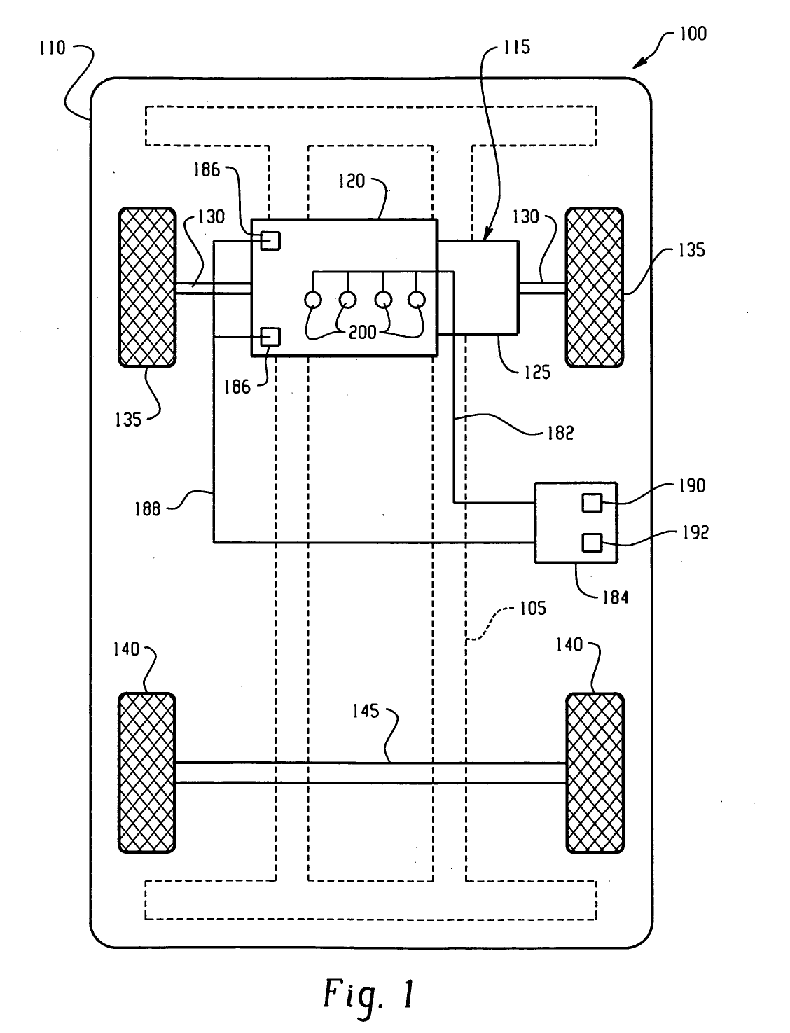

FIG. 1 is an exemplary embodiment of a vehicle 100 having a chassis 105, a body 110 disposed on the chassis 105, and a drive train 115 disposed on the chassis 105. In an exemplary embodiment, the drive train 115 includes an engine 120, a transmission 125, a drive axle 130, and driven wheels 135. While not specifically illustrated, it will be appreciated that rear wheels 140, connected by rear axle 145, may also (or alternatively) be driven by engine 120 and transmission 125.

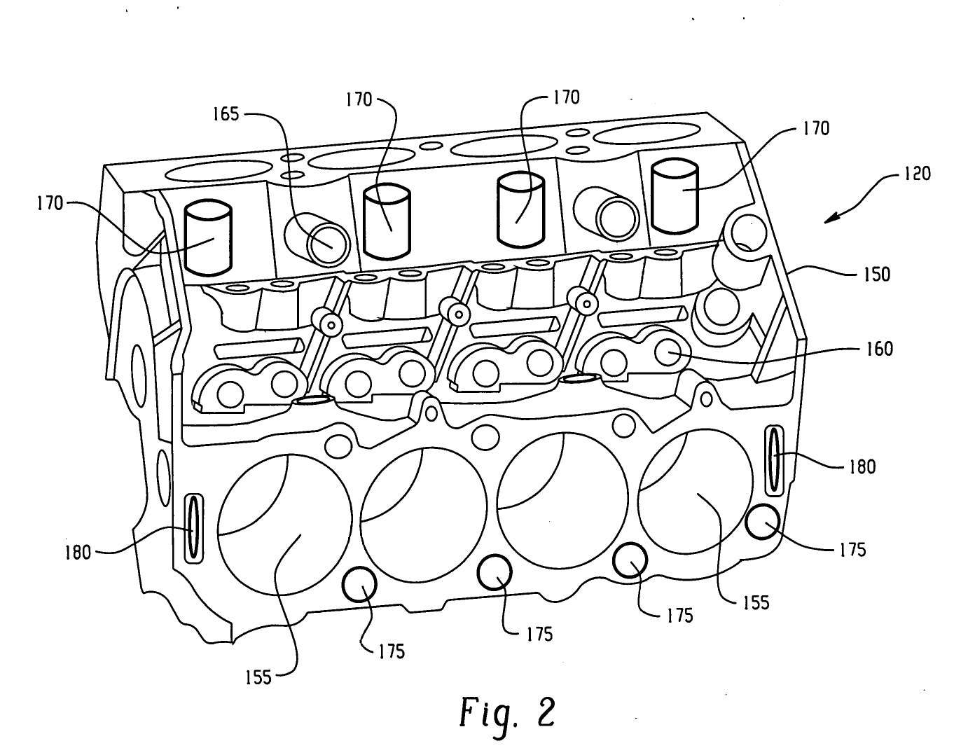

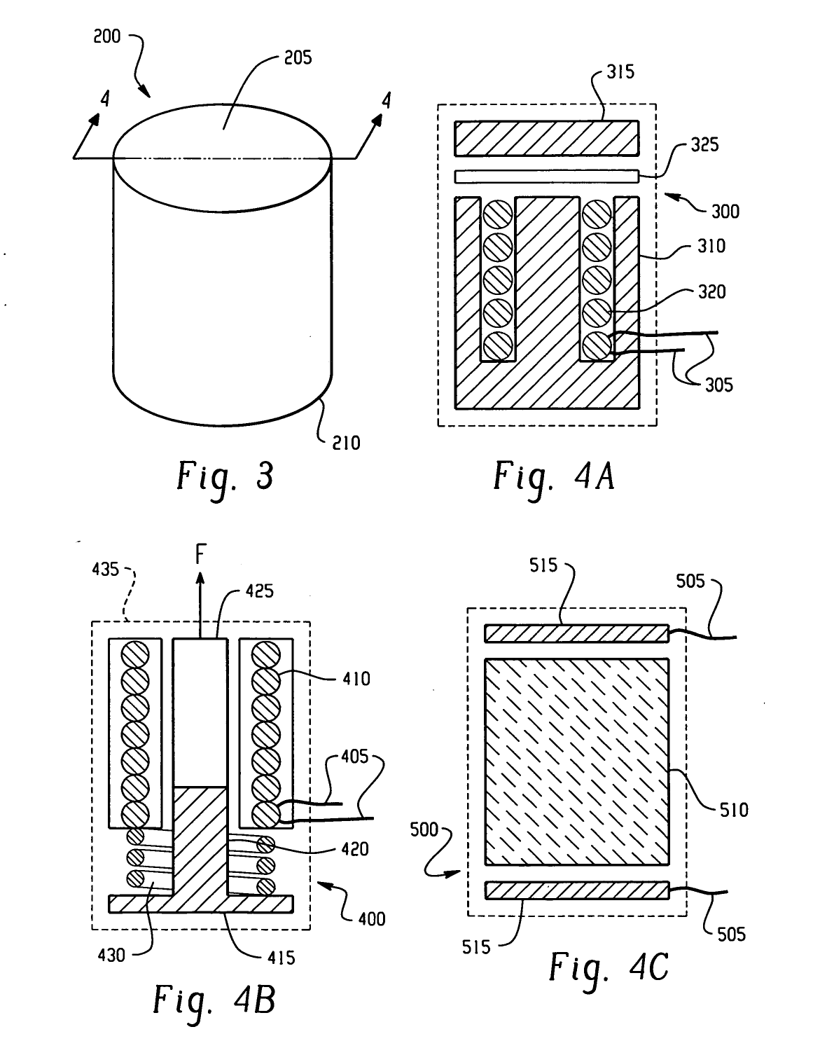

In an embodiment, engine 120 includes an engine block that forms a housing 150, best seen by now referring to FIG. 2, for receiving the internal working components of the engine 120. Formed within the housing 150 are voids 155 for receiving the engine pistons (not shown), voids 160 for receiving the engine valves (not shown), voids 165 that may be used for engine coolant, and voids 170 that may be used for receiving a damping element 200, illustrated in FIG. 3 and discussed later. While voids 170 and damping element 200 are illustrated having a generally cylindrical shape, it will be appreciated the voids 170 and damping element 200 may have any shape suitable for the purposes disclosed herein. Also, while voids 170 are illustrated being disposed toward the top of housing 150 of engine 120, it will be appreciated that other voids 175 and 180 for example, may be situated at different locations within housing 150 and oriented in a different manner.

In an exemplary embodiment, damping element 200, referring now to FIG. 3, is a passive damping element that is placed within any or all of voids 170, 175, and 180, which will hereinafter be collectively referred to as void 170 unless otherwise stated. Exemplary materials that may be used for passive damping element 200 include epoxy, rubber, polymer foam, liquid metal, metallic foam, phase-change material, shape memory alloy, a material having a negative Poisson's ratio, for example, or any other material exhibiting an elastomeric-like characteristic and being suitable for use in the operating environment as disclosed herein. Exemplary embodiments of a shape memory alloy material includes NiTi-based shape memory alloys and Cu-Al-Mn-based shape memory alloys, for example. Exemplary embodiments of a material having a negative Poisson's ratio includes conventional low density open-cell polymer foam having a re-entrant structure, for example. In an embodiment, combinations of the foregoing materials may be used.

In an alternative exemplary embodiment, damping element 200 may be an active damping element, such as a magnetorheological fluid device, an electrorheological fluid device, an electro-active polymer device, a solenoid device, a piezoelectric device, for example, or any other device responsive to a control signal for changing the damping characteristics at void 170 in a manner that will now be discussed with reference to FIGS. 1-3 and FIGS. 4A-4C collectively.

FIGS. 4A-4C illustrate exemplary section cuts through the damping element 200 illustrated in FIG. 3. As used herein, reference to damping element 200 in connection with FIG. 3 only refers to a passive damping element, while reference to damping element 200 in connection with FIGS. 4A-4C refers to an active damping element.

FIG. 4A illustrates a magnetorheological (MR) active damping element device 300 having electrical leads 305, FIG. 4B illustrates a solenoid active damping element device 400 having electrical leads 405, and FIG. 4C illustrates a piezoelectric active damping element device 500 having electrical leads 505.

Referring now back to FIG. 1, electrical leads 305, 405 and 505 are depicted generally by numeral 182, which may also be viewed as a communication bus that connects between damping elements 200 (active damping elements 300, 400 or 500) and a controller 184. In an embodiment, controller 184 receives an input signal from vibration sensors 186, such as accelerometers, strategically placed on engine 120. Sensors 186 are in signal communication with controller 184 via signal path 188. In response to a sensed vibration at the metal housing 150 of engine 120, controller 184 initiates a signal directed to the active damping element 300, 400, 500 that changes the operating characteristics of active damping element 300, 400, 500 in such a manner as to change the damping characteristics at the void 170 of the metal housing 150, which will now be discussed with reference to FIGS. 4A-4C separately.

Referring now to FIG. 4A, an exemplary embodiment of MR acting damping device 300 includes a first stator portion 310, a second stator portion 315 in field communication with the first portion 310, a magnetic field generator (such as a coil) 320 for generating a magnetic field that traverses a magnetic path defined by first and second portions 310, 315, and a MR fluid 325 disposed between the first and second portions 310, 315. Electrical leads 305 provide signal communication between controller 184 and coil 320. In response to a sensed vibration at the metal housing 150, the controller 184 initiates a signal directed to the field generator 320 to change the magnetic field at the MR fluid 325. In response to the presence of a high magnetic field, the viscosity of the MR fluid 325 increases, thereby changing the damping characteristics at the void 170 of the metal housing 150.

Referring now to FIG. 4B, an exemplary embodiment of solenoid active damping device 400 includes a coil 410 for generating a magnetic field, an armature 415 having a first magnetic portion 420 and a second non-magnetic portion 425, and a bias spring 430 for biasing the armature 415 downward (relative to the orientation of FIG. 4B). Electrical leads 405 provide signal communication between controller 184 and coil 410. In response to a sensed vibration at the metal housing 150, the controller 184 initiates a signal directed to the coil 410, which when energized generates a magnetic field that traverses a path through the center of coil 410. The influence of the magnetic field on armature 415 is such that the first magnetic portion 420 experiences a force F in an upward direction that tends to drive the first magnetic portion 420 toward the center of coil 410. In response to armature 415 being driven upward, the second non-magnetic portion 425 of armature 415 is forced against a surface within the void 170, the surface of void 170 being generally depicted by dashed boundary line 435, thereby changing the damping characteristics at the void 170 of the metal housing 150.

Referring now to FIG. 4C, an exemplary embodiment of piezoelectric active damping device 500 includes a piezoelectric material 510 (such as quartz, SiO2, or barium titanate, BaTiO3, for example) and electrodes 515 in electrical contact therewith. Electrical leads 505 provide signal communication between controller 184 and electrodes 515. In response to a sensed vibration at the metal housing 150, the controller 184 initiates a signal directed to the electrodes 515 of the piezoelectric device 500 so as to cause the piezoelectric device 500 to vibrate in a manner that is counterproductive to the sensed vibration thereby changing the damping characteristics at the void 170 of the metal housing 150. In an embodiment, it is contemplated that a piezoelectric active damping device may be used to reduce high frequency vibrations at the engine 120.

By controlling active damping element 300, 400, or 500 in the manner described above, the axial stiffness of void 170 with damping element 200, which may be viewed generally by considering the axial stiffness of damping element 200 between endwalls 205, 210, may be changed, thereby changing the natural frequency of vibration of the engine block of engine 120. By the implementation of appropriate control algorithms at controller 184, it is contemplated that the damping characteristics of active damping element 300, 400, 500 may be tuned to match the real time engine noise spectra, thereby substantially reducing the engine noise transmitted to the passenger compartment of the vehicle.

In view of the foregoing, an embodiment of controller 184 is responsive for damping vehicle noise by: sensing a vibration at an engine 120 of a vehicle 100; in response to the sensed vibration, generating a control signal to activate a damping element 300, 400, 500 disposed at a void 170 within the engine 120; and in response to the control signal, causing the damping element 300, 400, 500 to change in such a manner as to change the damping characteristics at the void 170 of the engine 120. An embodiment of controller 184 may cause the damping element 300, 400, 500 to exert a force on a surface 205, 210 at the void 170 that is counterproductive to the sensed vibration, and another embodiment of controller 184 may cause the damping element 300, 400, 500 to vibrate in a manner counterproductive to the sensed vibration.

While embodiments of the invention have been described employing three different types of active damping devices, it will be appreciated that the scope of the invention is not so limited, and that the scope of the invention broadly applies to other active damping devices, such as those previously mentioned, or otherwise.

Also, while embodiments of the invention have been described and illustrated with specific configurations for the exemplary damping elements, whether passive or active, it will be appreciated that the invention is not so limited and that any damping element configuration serving the purposes disclosed herein are also intended to be within the scope of the invention.

An embodiment of the invention may be embodied in the form of computer-implemented processes and apparatuses for practicing those processes. The present invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to dampen vehicle noise generally, and dampen engine noise particularly.

In an embodiment, controller 184 includes a processing circuit 190 and a storage medium 192, readable by the processing circuit, storing instruction for execution by the processing circuit 190 for damping vehicle noise as previously discussed and described.

As disclosed, some embodiments of the invention may include some of the following advantages: reduced engine vibration noise; tunable damping characteristics that match the real time engine noise spectra; use of existing cored channels for placement of sound absorbing passive damping elements; and, the ability to mix and match different passive and active damping elements to match different engine characteristics.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A vehicle, comprising:
a chassis;
a body disposed on the chassis; and
a drive train disposed on the chassis, the drive train comprising a metal housing having a void and a damping element disposed within the void.

2. The vehicle of claim 1, wherein:
the metal housing comprises a plurality of voids each have a damping element disposed therein.

3. The vehicle of claim 1, wherein:
the drive train comprises an engine that comprises the metal housing, the metal housing defining an engine block.

4. The vehicle of claim 1, wherein:
the damping element comprises a passive damping element made from a material comprising epoxy, rubber, polymer foam, liquid metal, metallic foam, phase- change material, a negative Poisson's ratio, or any combination comprising at least one of the foregoing materials.

5. The vehicle of claim 1, wherein:
the damping element comprises an active damping element.

6. The vehicle of claim 5, wherein:
the active damping element comprises a magnetorheological fluid device, an electrorheological fluid device, an electro-active polymer device, a solenoid device, a piezoelectric device, a shape memory alloy device, or any combination comprising at least one of the foregoing devices.

7. The vehicle of claim 5, wherein the active damping element comprises a magnetorheological (MR) fluid device having a magnetic field generator in field communication with a MR fluid, and further comprising:
a controller in signal communication with the field generator;
a sensor in signal communication with the controller and disposed to sense a vibration at the metal housing;
wherein in response to a sensed vibration at the metal housing the controller initiates a signal directed to the field generator to change the magnetic field at the MR fluid thereby changing the damping characteristics at the void of the metal housing.

8. The vehicle of claim 5, wherein the active damping element comprises solenoid device having a coil in field communication with an armature, and further comprising:
a controller in signal communication with the coil;
a sensor in signal communication with the controller and disposed to sense a vibration at the metal housing;
wherein in response to a sensed vibration at the metal housing the controller initiates a signal directed to the coil such that the armature exerts a force on a surface within the void thereby changing the damping characteristics at the void of the metal housing.

9. The vehicle of claim 5, wherein the active damping element comprises a piezoelectric device, and further comprising:
a controller in signal communication with the piezoelectric device;
a sensor in signal communication with the controller and disposed to sense a vibration at the metal housing;
wherein in response to a sensed vibration at the metal housing the controller initiates a signal directed to the piezoelectric device so as to cause the piezoelectric device to vibrate in a manner that is counterproductive to the sensed vibration thereby changing the damping characteristics at the void of the metal housing.

10. An engine block for a vehicle, comprising:
a housing having a void; and
a damping element disposed within the void.

11. The engine block of claim 10, wherein:
the damping element comprises a passive damping element made from a material comprising epoxy, rubber, polymer foam, liquid metal, metallic foam, phase-change material, a negative Poisson's ratio, or any combination comprising at least one of the foregoing materials.

12. The engine block of claim 10, wherein:
the damping element comprises a magnetorheological fluid device, an electrorheological fluid device, an electro-active polymer device, a solenoid device, a piezoelectric device, a shape memory alloy device, or any combination comprising at least one of the foregoing active damping element devices.

13. A method of damping vehicle noise, comprising:
sensing a vibration at an engine of the vehicle;
in response to the sensed vibration, generating a control signal to activate a damping element disposed at a void within the engine; and
in response to the control signal, causing the damping element to change in such a manner as to change the damping characteristics at the void of the engine.

14. The method of claim 13, further comprising:
causing the damping element to exert a force on a surface at the void that is counterproductive to the sensed vibration.

15. The method of claim 13, further comprising:
causing the damping element to vibrate in a manner counterproductive to the sensed vibration.

16. A controller for damping vehicle noise, comprising:
a processing circuit; and
a storage medium, readable by the processing circuit, storing instructions for execution by the processing circuit for:
receiving a signal representative of a sensed vibration at a metal housing of the vehicle;
in response to the sensed vibration, generating a control signal to activate a damping element disposed at a void within the metal housing; and
causing the damping element to change in such a manner as to change the damping characteristics at the void of the metal housing.
